(19) United States
(12) Patent Application Publication
(10) Pub. No.: US 2026/0370552 A1
(43) Pub. Date: Nov. 19, 2026

(54) SYSTEM AND METHOD OF USING ARTIFICIAL INTELLIGENCE TO PROVIDE ADAPTIVE OFFLINE ANALYSIS POLICIES FOR TRAFFIC SPIKES IN INFORMATION HANDLING SYSTEMS

(71) Applicant: DELL PRODUCTS L.P., Round Rock, TX (US)

(72) Inventors: Avinash Kumar, Patna (IN); Nitesh Pandey, Bangalore (IN); Parminder Singh Sethi, Ludhiana (IN)

(21) Appl. No.: 19/210,432

(22) Filed: May 16, 2025

(51) Int. Cl. H04L 41/0894; H04L 41/16; H04L 43/08

(52) U.S. Cl. CPC H04L 41/0894; H04L 41/16; H04L 43/08

(57) ABSTRACT

An information handling system includes an artificial intelligence (AI) adaptive policy model and a processor operably coupled to the computer readable medium to access the AI adaptive policy model to monitor one or more system resources and determine when a spike in resource usage occurs. When a spike in resource usage occurs, the processor access the AI adaptive policy model to gather data related to the spike to determine a spike reasoning for the spike and provide an adaptive spike management policy based on the spike reasoning.

### FIELD OF THE DISCLOSURE

The present disclosure generally relates to information handling systems, and more particularly relates to providing offline analysis policies in response to traffic spikes in information handling systems.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system includes a computer readable medium with an artificial intelligence (AI) adaptive policy model and a processor operably coupled to the computer readable medium to access the AI adaptive policy model to monitor one or more system resources and determine when a spike in resource usage occurs. When a spike in resource usage occurs, the system may gather data related to the spike to determine a spike reasoning for the spike and provide an adaptive spike management policy based on the spike reasoning.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of a network system according to an embodiment of the present disclosure;

FIG. 2 is a block diagram of an information handling system according to an embodiment of the present disclosure;

FIG. 3 is a flow diagram of a method of using artificial intelligence to provide adaptive offline analysis policies for dealing with traffic spikes in an information handling system according to an embodiment of the present disclosure; and

FIG. 4 is a block diagram of still another information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

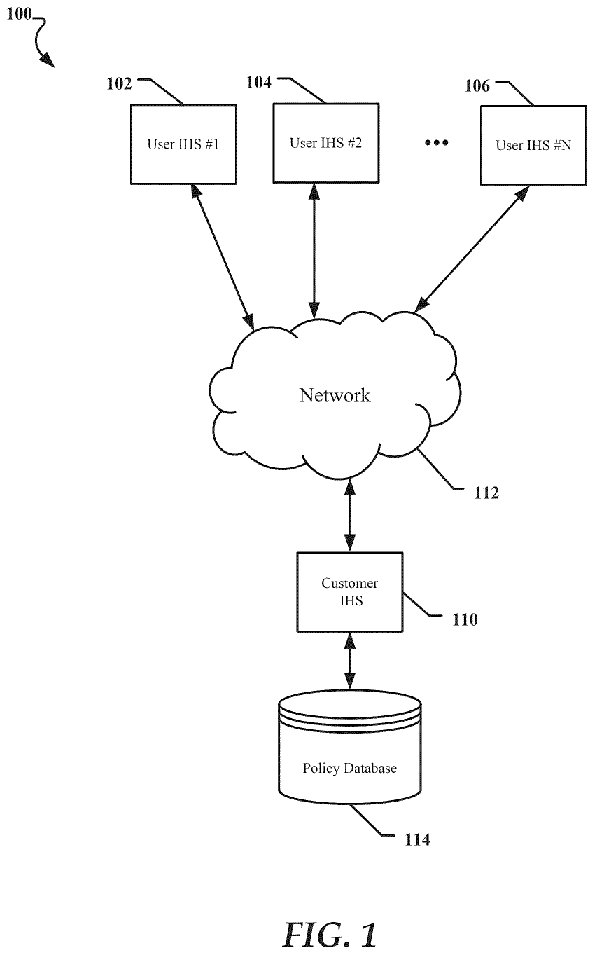

FIG. 1 shows a network system 100 that may include a first user information handling system 102, a second user information handling system 104, and an Nth user information handling system 106 that are operably coupled to a customer information handling system 110 via a network 112 such as the Internet. A policy database 114 may be operably coupled to the customer information handling system 110. The policy database 114 may include one or more offline analysis policies that may be retrieved and executed based on traffic spikes that may occur during operation of the customer information handling system 110 as created by the user information handling systems 102, 104, 106.

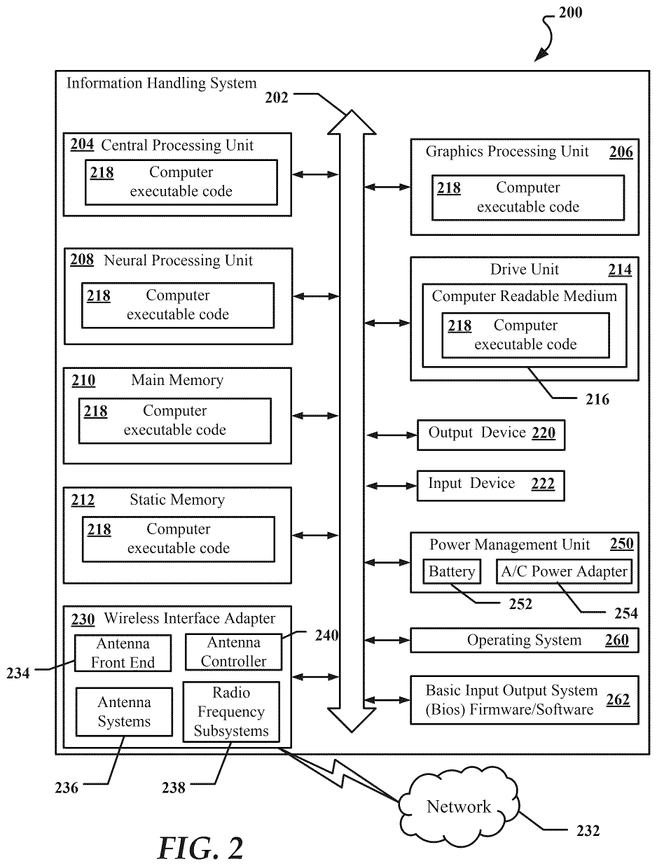

FIG. 2 illustrates an information handling system 200 having various components disposed therein. For purposes of this disclosure, the information handling system 200 may include any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, the information handling system 200 can be a personal computer, a mobile device (e.g., a personal digital assistant (PDA) or a smart phone), server (e.g., a blade server or a rack server), a consumer electronic information handling system, a network server or storage device, a network router, switch, or bridge, wireless router, or other network communication information handling system, a network connected device (cellular telephone, tablet information handling system, etc.), IoT computing device, wearable computing device (e.g., a smart watch or smart glasses), a set-top box (STB), a mobile device, a palmtop computer, a laptop computer, a desktop computer, a communications device, an access point (AP), a base station transceiver, a wireless telephone, a land-line telephone, a control system, a camera, a scanner, a facsimile machine, a printer, a pager, a personal device, a web appliance, or any other suitable machine capable of executing a set of instructions (sequential or otherwise) that specify actions to be taken by that machine, and can vary in size, shape, performance, price, and functionality.

In a networked deployment, for example, the information handling system 200 may operate in the capacity of a server or as a client computer in a server-client network environment, or as a peer computer system in a peer-to-peer (or distributed) network environment. In a particular embodiment, the information handling system 200 can be implemented using electronic information handling systems that provide voice, video or data communication. For example, an information handling system 200 may be any mobile or other computing device capable of executing a set of instructions (sequential or otherwise) that specify actions to be taken by that machine. Further, while a single information handling system 200 is illustrated, the term “system” shall also be taken to include any collection of systems or sub-systems that individually or jointly execute a set, or multiple sets, of instructions to perform one or more computer functions.

In general, the information handling system 200 can include memory (volatile (e.g., random-access memory, etc.), nonvolatile (read-only memory, flash memory etc.) or any combination thereof), one or more processing resources, such as a central processing unit (CPU), a graphics processing unit (GPU), a neural processing unit (NPU), hardware or software control logic, or any combination thereof. Additional components of the information handling system 200 can include one or more storage devices, one or more communications ports for communicating with external devices, as well as, various input and output (I/O) devices, such as a keyboard, a mouse, a video/graphic display, or any combination thereof. The information handling system 200 can also include one or more buses operable to transmit communications between the various hardware components. Portions of an information handling system 200 may themselves be considered information handling systems 200. The information handling system 200 can include devices or modules that embody one or more of the devices or execute instructions for the one or more systems and modules described herein, and operates to perform one or more of the methods described herein.

As illustrated in FIG. 2, in particular, the information handling system 200 can include one or more buses 202 operable to transmit communications between the various hardware components such as any combination of various input and output (I/O) devices described herein. The information handling system 200 can include one or more processors operably coupled to the bus 202. For example, the information handling system 200 can include a central processing unit (CPU) 204, a graphics processing unit (GPU) 206, a neural processing unit (NPU) 208, or any combination thereof. The CPU 204, the GPU 206, and the NPU 208 may include control logic and may individually, or collectively, operate to execute code that is either firmware or software code. Moreover, the information handling system 200 can include one or more memory devices such as a main memory 210, a static memory 212, and a drive unit 214 having a computer readable medium 216 disposed therein. The drive unit 214 can include a hard drive unit, a solid state drive unit, or a combination thereof. Further, the various memory devices 210, 212, 214, 216 may include volatile memory (e.g., random-access memory, etc.), nonvolatile memory (read-only memory, flash memory etc.) or any combination thereof).

The information handling system 200 includes computer executable code 218 that may reside on, or be executed by, the CPU 204, the GPU 206, the NPU 208, the main memory 210, the static memory 212, the computer readable medium 216 of the drive unit 214, or any combination thereof. The computer executable code 218 can include instructions (e.g., software algorithms), parameters, and profiles. The computer executable code 218 that may operate on servers or systems, remote data centers, or on-box in individual client information handling systems according to various embodiments herein. In some embodiments, it is understood any or all portions of the computer executable code 218 may operate on, or be executed by, the CPU 204, the GPU 206, the NPU 208, the main memory 210, the static memory 212, the computer readable medium 216 of the drive unit 214, or any combination thereof. In some embodiments, it is understood any or all portions of computer executable code 218 may operate on a plurality of information handling systems 200.

As shown, the information handling system 200 may further include an output device 220 such as a video display output. In an embodiment, the output device 220 may include a liquid crystal display (LCD), an organic light emitting diode (OLED), a flat panel display, a solid-state display, a curved panel display, a flexible panel display, or a combination thereof. Further, the output device 220 may include one or more sound output devices such as speakers. As further illustrated, the information handling system 200 may include an input device 222 that may include an alpha numeric input device, such as a keyboard, and/or a cursor control device, such as a mouse, touchpad, or gesture or touch screen input device.

The information handling system 200 may also include a network interface device, shown as a wireless interface adapter 230, that can provide connectivity to a network 232, e.g., a wide area network (WAN), a local area network (LAN), wireless local area network (WLAN), a wireless personal area network (WPAN), a wireless wide area network (WWAN), or another network. In an embodiment, the WAN, WWAN, LAN, and WLAN may each include an access point used to operatively coupled the information handling system 200 to a network. In a specific embodiment, the network 254 may include macro-cellular connections via one or more base stations, one or more wireless access points (for example Wi-Fi or WiGig), one or more licensed or unlicensed WWAN small cell base stations, or a combination thereof. Further, network connectivity may be a wired or wireless connection.

As depicted, the wireless interface adapter 230 may include an antenna front end 234, one or more antenna systems 236, one or more radio frequency subsystems 238, and an antenna controller 240. These components may include transmitter/receiver circuitry, modem circuitry, one or more radio frequency front end circuits, one or more wireless controller circuits, amplifiers, and other circuitry of the wireless interface adapter, such as one or more antenna ports used for wireless communications via multiple radio access technologies. Each radio frequency subsystem 234 may communicate with one or more wireless technology protocols. The radio frequency subsystem 234 may contain individual subscriber identity module (SIM) profiles for each technology service provider and their available protocols for any operating subscriber-based radio access technologies such as cellular LTE communications.

In some embodiments of the present disclosure, the wireless interface adapter 230 may operate two or more wireless links. In a further embodiment, the wireless interface adapter 230 may operate the two or more wireless links with a single, shared communication frequency band such as with the 5G standard relating to unlicensed wireless spectrum for small cell 5G operation or for unlicensed Wi-Fi WLAN operation in an example embodiment. For example, a 2.4 GHz/2.5 GHz or 5 GHz wireless communication frequency bands may be apportioned under the 5G standards for communication on either small cell WWAN wireless link operation or Wi-Fi WLAN operation. In some embodiments, the shared, wireless communication band may be transmitted through one or a plurality of antennas or antennas may be capable of operating at a variety of frequency bands.

The wireless interface adapter 230 may operate in accordance with any wireless data communication standards. To communicate with a wireless local area network, standards including IEEE 802.11 WLAN standards (such as IEEE 802.11ax-2021 (Wi-Fi 6E, 6 GHz)), IEEE 802.15 WPAN standards, WWAN such as 3GPP or 3GPP2, or similar wireless standards may be used. Wireless interface adapter 230 may connect to any combination of macro-cellular wireless connections including 2G, 2.5G, 3G, 4G, 5G or the like from one or more service providers. Utilization of radiofrequency communication bands according to several example embodiments of the present disclosure may include bands used with the WLAN standards and WWAN carriers which may operate in both licensed and unlicensed spectrums. For example, both WLAN and WWAN may use the Unlicensed National Information Infrastructure (U-NII) band which typically operates in the ~5 MHz frequency band such as 802.11 a/h/j/n/ac/ax (such as center frequencies between 5.170-7.125 GHZ). WLAN, for example, may operate at a 2.4 GHz band, 5 GHz band, and/or a 6 GHz band according to, for example, Wi-Fi, Wi-Fi 6, or Wi-Fi 6E standards. WWAN may operate in a number of bands, some of which are proprietary but may include a wireless communication frequency band.

For example, low-band 5G may operate at frequencies similar to 4G standards at 600-850 MHz. Mid-band 5G may operate at frequencies between 2.5 and 3.7 GHZ. Additionally, high-band 5G frequencies may operate at 25 to 39 GHz and even higher. In additional examples, WWAN carrier licensed bands may operate at the new radio frequency range 2 (NRFR1), NFRF2, bands, and other known bands. Each of these frequencies used to communicate over the network 254 may be based on the radio access network (RAN) standards that implement, for example, eNodeB or gNodeB hardware connected to mobile phone networks (such as cellular networks) used to communicate with the information handling system 200. In the example embodiment, mobile device 200 may also include both unlicensed wireless RF communication capabilities as well as licensed wireless RF communication capabilities. For example, licensed wireless RF communication capabilities may be available via a subscriber carrier wireless service operating the cellular networks. With the licensed wireless RF communication capability, a WWAN RF front end of the information handling system 200 may operate on a licensed WWAN wireless radio with authorization for subscriber access to a wireless service provider on a carrier licensed frequency band.

The wireless interface adapter 230 can represent an add-in card, wireless network interface module that is integrated with a main board of the information handling system or integrated with another wireless network interface capability, or any combination thereof. In an embodiment the wireless interface adapter 230 may include one or more radio frequency subsystems 230 including transmitters and wireless controllers for connecting via a multitude of wireless links. In an example embodiment, an information handling system may have an antenna system transmitter for 5G small cell WWAN, Wi-Fi WLAN or WiGig connectivity and one or more additional antenna system transmitters for macro-cellular communication. The radio frequency subsystems 230 include wireless controllers to manage authentication, connectivity, communications, power levels for transmission, buffering, error correction, baseband processing, and other functions of the wireless interface adapter 230.

The information handling system 200 may further include a power management unit (PMU) 250. The PMU 250, also known as a power supply unit (PSU), may manage the power provided to the components of the information handling system 200 such as the CPU 204, the GPU 206, the NPU 208, the main memory 210, the static memory 212, the drive unit 214, the output device 220, the input device 222, the wireless interface adapter 230, any combination thereof, and any other components that may require power when a power button on the information handling system 200 is actuated by a user. In an embodiment, the PMU 250 may monitor power levels and be electrically coupled to the information handling system 200 to provide this power and coupled to bus 208 to provide or receive data or instructions. The PMU 250 may regulate power from a power source such as a battery 252 or A/C power adapter 254.

In an embodiment, the battery 252 may be charged via the A/C power adapter 254 and provide power to the components of the information handling system 200 when A/C power from the A/C power adapter 254 is removed.

FIG. 2 further indicates that the information handling system 200 includes an operating system (OS) 260, a basic input/output system (BIOS) firmware/software 262, one or more application programs, or a combination thereof that may be part of the computer executable code 218 that is executed at the CPU 204, the GPU 206, the NPU 208, or a combination thereof, and stored the main memory 210, the static memory 212, the computer readable medium 216 of the drive unit 214, or any combination thereof. The BIOS firmware/software 262 functions to initialize information handling system 200 on power up, to launch the OS 260, and to manage input and output interactions between the OS 260 and the other elements of information handling system 200. In a particular embodiment, BIOS firmware/software 262 resides in the main memory 208 or the static memory 212, and includes machine-executable code that is executed by the CPU 204 to perform various functions of information handling system 200 as described herein.

In another embodiment (not illustrated), application programs and BIOS firmware/software 262 can reside in another storage medium of information handling system 200. For example, application programs and BIOS firmware/software 262 can reside in the drive unit 214, in a ROM (not illustrated) associated with information handling system 200, in an option-ROM (not illustrated) associated with various devices of information handling system 200, in a storage system (not illustrated) associated with network channel of the wireless interface adapter 230, in another storage medium of information handling system 200, or a combination thereof. Computer executable code 218 for application programs and BIOS firmware/software 238 can each be implemented as single programs, or as separate programs carrying out the various features as described herein.

As stated above, the information handling system 200 may connect to the external wireless network 232. In particular, the wireless network 232 may have a wireless mesh architecture in accordance with mesh networks described by the wireless data communications standards or similar standards in some embodiments but not necessarily in all embodiments. The wireless interface adapter 230 may connect to the external wireless network 233 via a WPAN, WLAN, WWAN or similar wireless switched Ethernet connection in some embodiments. The wireless data communication standards set forth protocols for communications and routing via access points, as well as protocols for a variety of other operations. Other operations may include handoff of client devices moving between nodes, self-organizing of routing operations, or self-healing architectures in case of interruption.

In some embodiments, software, firmware, dedicated hardware implementations such as application specific integrated circuits, programmable logic arrays and other hardware information handling systems can be constructed to implement one or more of the methods described herein. Applications that may include the apparatus and systems of various embodiments can broadly include a variety of electronic and computer systems. One or more embodiments described herein may implement functions using two or more specific interconnected hardware modules or information handling systems with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by firmware or software programs executable by a controller or a processor system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 216 that includes computer executable code 218 (for example instructions, parameters, and profiles), or receives and executes computer executable code 218 (for example instructions, parameters, and profiles) responsive to a propagated signal; so that a device connected to the wireless network 232 can communicate voice, video or data over the wireless network 232. Further, the computer executable code 218 may be transmitted or received over the wireless network 232 via the network interface device, that is the wireless interface adapter 230.

The wireless interface adapter 230 represents a network interface card (NIC) disposed within information handling system 200, on a main circuit board of the information handling system 200, integrated onto another component such as the CPU 204, in another suitable location, or a combination thereof. The wireless interface adapter 230 can include another information handling system, a data storage system, another network, a grid management system, another suitable resource, or a combination thereof. In an embodiment, the wireless interface adapter 230 may operably connect to the network 232. The connection to network 232 may be wired or wireless.

The network interface device shown as wireless interface adapter 230 can provide connectivity to the network 232, such as a wide area network (WAN), a local area network (LAN), wireless local area network (WLAN), a wireless personal area network (WPAN), a wireless wide area network (WWAN), or another network. Connectivity may be via wired or wireless connection. The wireless interface adapter 230 may include an adaptive massive MIMO Multiplexer with transmitter/receiver circuitry, wireless controller circuitry, amplifiers and other circuitry for wireless communications. The wireless interface adapter 230 may also include antenna systems 236 as described above which may be tunable antenna systems for use with the system and methods disclosed in the embodiments herein. The antenna controller 240 may also include wireless controllers to manage authentication, connectivity, communications, power levels for transmission, buffering, error correction, baseband processing, and other functions of the wireless interface adapter 230.

The information handling system 200 can include a set of computer executable code 218 that can be executed to cause the information handling system 200 to perform any one or more of the methods or computer-based functions disclosed herein. For example, computer executable code 218 may execute various software applications, software agents, or other aspects or components. Various software modules comprising application computer executable code 218 may be coordinated by the OS 260, and/or via an application programming interface (API). An example operating system may include Windows®, Android®, and other OS types known in the art. Example APIs may include Win 32, Core Java API, or Android APIs.

The drive unit 214 may include a computer-readable medium 216 in which one or more sets of computer executable code 218 such as software can be embedded to be executed by the CPU 204, the GPU 206, the NPU 208, or a combination thereof, to perform the processes described herein. Similarly, main memory 204 and static memory 206 may also contain a computer-readable medium for storage of one or more sets computer executable code 218 (e.g., instructions, parameters, or profiles). The drive unit 214 or static memory 212 also contain space for data storage. Further, the computer executable code 218 may embody one or more of the methods or logic as described herein. In a particular embodiment, the computer executable code 218 may reside completely, or at least partially, within the main memory 204, the static memory 206, and/or within the disk drive 216 during execution by the CPU 204 of the information handling system 200. The CPU 204, the GPU 206, and the NPU 208 also may include computer-readable media. The NPU 208 may include computer executable code 218 that includes an artificial intelligence (AI) adaptive policy model that provides adaptive offline analysis policies for handling traffic spikes as they occur in the information handling system 200.

The main memory 208, the static memory 212, or other memory of the embodiments described herein may contain computer-readable medium (not shown), such as RAM. An example of main memory 208 can include random access memory (RAM) such as static RAM (SRAM), dynamic RAM (DRAM), non-volatile RAM (NV-RAM), or the like, read only memory (ROM), another type of memory, or a combination thereof. The static memory 212 may contain computer-readable medium (not shown), such as NOR or NAND flash memory in some example embodiments. The drive unit 214 may include access to a computer-readable medium 216 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In other embodiments, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

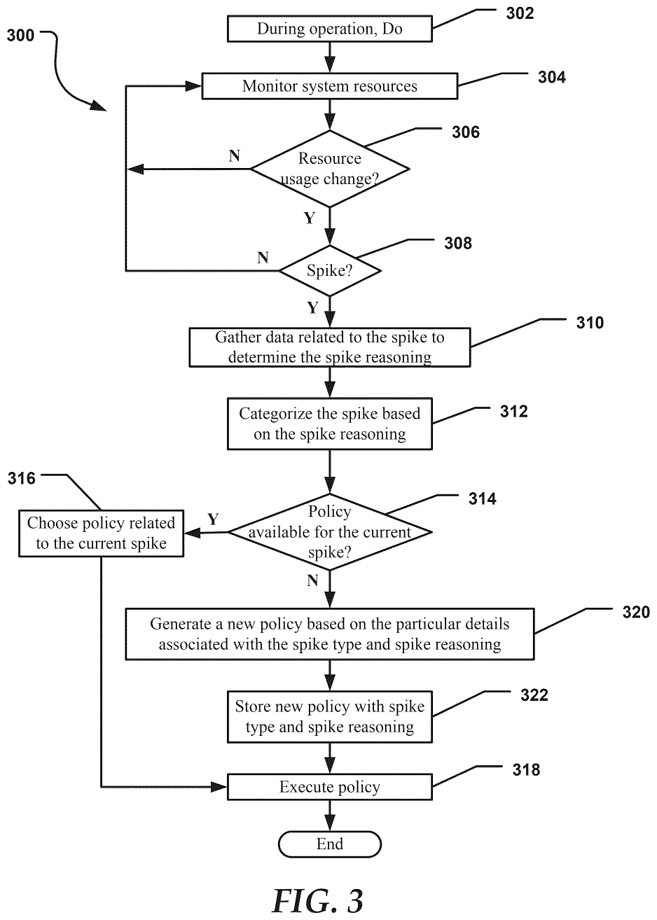

FIG. 3 illustrates a flow diagram of a method 300 of using artificial intelligence to provide adaptive office analysis policies for handling traffic spikes in an information handling system. The method 300 may be performed, for example, in an information handling system that is configured according to at least one embodiment of an information handling system that is described in the present disclosure and the method 300 commences at block 302. It will be readily appreciated that not every method step set forth in this flow diagram is always necessary, and that certain steps of the methods may be combined, performed simultaneously, in a different order, or perhaps omitted, without varying from the scope of the disclosure. The method steps depicted in FIG. 3 may be executed, or employed in whole, or in part, by any of the processors disclosed herein, any other type of controller, device, module, processor, or any combination thereof, operable to employ, or otherwise execute, all, or portions of, the method 300 of FIG. 3.

Beginning at block 302, the method 300 includes entering a do loop wherein during operation of an information handling system, or multiple interconnected information handling systems, the following steps are performed. At block 304, the method 300 may include monitoring one or more system resources. These system resources may include network resources, applications, processors, memories, network traffic, online resources (such as websites), etc., or any combination thereof. Moving to decision step 306, the method 300 includes determining if there has a been a change in usage of any of the resources. For example, the change could include an increase in network latency, a decrease in network performance (opening files or accessing websites), a decrease in any application performance, an increase in processor usage, an increase in memory utilization, an increase in network traffic, an increase in user access requests, unavailability of one or more hosted websites, an increase in download requests, an increase in image views, an increase in video views, an increase in add-to-carts, an increase in orders, an increase in sales, an increase in any other user requests, etc., or any combination thereof.

If there are no changes in the usages of the resources, the method 300 may return to block 304 and continue as described herein. However if the method 300 determines that there is a change in usage in any of the resources, the method 300 may proceed to decision step 308. At decision step 308, the method 300 may determine whether any of these resource usage changes is indicative of a spike.

For example, an increase in network latency above a predetermined threshold over a short time may be indicative of a spike. A decrease in network performance (opening files or accessing websites) below a threshold over a short time may be indicative of a spike. A decrease in application performance below a threshold over a short time may be indicative of a spike. An increase in processor usage above a predetermined threshold over a short time may be indicative of a spike. An increase in memory utilization above a predetermined threshold over a short time may be indicative of a spike. An increase in network traffic above a predetermined threshold over a short time may be indicative of a spike.

Moreover, an increase in user access requests above a predetermined threshold over a short time may be indicative of a spike. Increased unavailability of one or more hosted websites above a predetermined threshold over a short time may be indicative of a spike. An increase in download requests above a predetermined threshold over a short time may be indicative of a spike. An increase in image views above a predetermined threshold over a short time may be indicative of a spike. An increase in video views above a predetermined threshold over a short time may be indicative of a spike. An increase in add-to-carts above a predetermined threshold over a short time may be indicative of a spike. An increase in orders above a predetermined threshold over a short time may be indicative of a spike. An increase in sales above a predetermined threshold over a short time may be indicative of a spike. Further, an increase in any other user requests above a predetermined threshold over a short time may be indicative of a spike.

Oftentimes, spikes are simply due to something, or someone, related to a product or video that suddenly goes viral. However, in other cases, the spikes may be part of broader, nefarious activity. Finally, the spikes may simply be an anomalies. In any event, if a spike occurs it needs to be managed properly.

Returning to decision 308, if the method 300 determines that the resource usage change is not a spike, the method 300 may return to block 304 where the method 300 may continue as described herein. Conversely, at decision 308, if the method 300 determines that the change in resource usage is indeed a spike, the method 300 proceeds to block 310 and the method 300 may include gathering data related to the spike to determine the spike reasoning, that is why the spike is occurring. This data may include user IP addresses, user locations, number of requests, request targets, network systems targeted, targeted applications, targeted websites, processors involved, memories involved, targeted files (such as for downloads), products placed in carts, products sold, etc. Moving to block 312, the method 300 may include categorizing the current spike as one of three spike types: a constructive spike, a destructive spike, or an anomalous spike—based on the spike reasoning.

In one aspect, a constructive spike is generally positive in nature and for example, the spike reasoning for a constructive spike may be an increase in sales that may occur when concert tickets are released. In another aspect, a destructive spike is generally nefarious and the spike reasoning for a destructive spike is to cause harm to an information handling system, or collection of interconnected information handling systems. A destructive spike may include, for example, a spike caused by a distributed denial-of-service (DDoS). Finally, in another aspect, an anomalous spike is a spike that does not include a clear spike reasoning. In any event, the different types of spikes may result in different offline policy analytics required to process the events and variables that led to the spike in order to prevent, or prepare for, future spikes.

From block 312, the method 300 may proceed to decision step 314, where the method 300 determines whether there is already a particular spike management policy available for the current spike-based on the type of spike, the spike reasoning, and the resource, or resources, that experienced the significant change in usage that led to the spike. The spike management policy may include a policy for reacting to and managing the spike real-time. Moreover, the spike management policy may include an offline analysis policy for analyzing and assessing the spike after it is managed and placed under control or effectively reduced. For example, in the case of a constructive spike associated with a flash sales increase, the spike management policy may include bringing online another information handling system to handle the customers associated with the flash sales increase. The offline analysis policy may include bringing the resource online prior to the offering of a similar item, or items, for sale. Further, for example, in the case of a destructive spike associated with a network attack, the spike management policy may include limiting access to a targeted network resource in real-time until the spike is under control. Further, the offline analysis policy may include flagging any data affected by the attack as polluted and excluding it from further analysis—thereby preventing the unnecessary use of resources. In either case, the method 300 may include providing a different type of spike management policy for different types of spikes. The spike management policy may be provided by the AI adaptive policy model.

Returning to decision 314, if there is a spike management policy available for the current spike, the method 300 may proceed to block 316 and the method 300 includes choosing the spike management policy related to the current spike. Thereafter, the method 300 may continue to block 318 and the method 300 may include executing the spike management policy for the current spike. Returning to decision 314, if there is not a policy for the current spike, the method 300 may move to block 320 and the method 300 may include dynamically generating a new policy that is adapted to the current spike based on the particular details associated with the current spike, e.g., the type of spike, the spike reasoning, and the resource, or resources, that experienced the significant change in usage that led to the spike. In particular, the spike management policy may be created and provided by the AI adaptive policy model for the current spike. At block 322, the method 300 may including storing the new policy along with an indicator of the spike type and spike reasoning associated with the current spike. Finally, the method 300 may, again, proceed to block 318 where the method 300 may include executing the spike management policy. Then the method 300 may end.

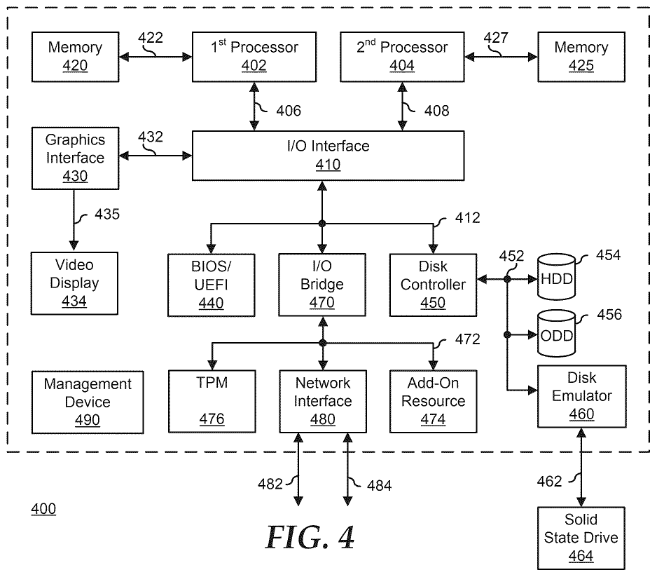

FIG. 4 shows a generalized embodiment of an information handling system 400 according to an embodiment of the present disclosure. Information handling system 400 may be substantially similar to the information handling system 100 of FIG. 1. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 400 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 400 can include processing resources for executing machine-executable code, such as a central processing unit (CPU), a programmable logic array (PLA), an embedded device such as a System-on-a-Chip (SoC), or other control logic hardware. Information handling system 400 can also include one or more computer-readable medium for storing machine-executable code, such as software or data. Additional components of information handling system 400 can include one or more storage devices that can store machine-executable code, one or more communications ports for communicating with external devices, and various input and output (I/O) devices, such as a keyboard, a mouse, and a video display. Information handling system 400 can also include one or more buses operable to transmit information between the various hardware components.

Information handling system 400 can include devices or modules that embody one or more of the devices or modules described below and operates to perform one or more of the methods described herein. Information handling system 400 includes a processors 402 and 404, an input/output (I/O) interface 410, memories 420 and 425, a graphics interface 430, a basic input and output system/universal extensible firmware interface (BIOS/UEFI) module 440, a disk controller 450, a hard disk drive (HDD) 454, an optical disk drive (ODD) 456, a disk emulator 460 connected to an external solid state drive (SSD) 464, an I/O bridge 470, one or more add-on resources 474, a trusted platform module (TPM) 476, a network interface 480, a management device 490, and a power supply 495. Processors 402 and 404, I/O interface 410, memory 420, graphics interface 430, BIOS/UEFI module 440, disk controller 450, HDD 454, ODD 456, disk emulator 460, SSD 464, I/O bridge 470, add-on resources 474, TPM 476, and network interface 480 operate together to provide a host environment of information handling system 400 that operates to provide the data processing functionality of the information handling system. The host environment operates to execute machine-executable code, including platform BIOS/UEFI code, device firmware, operating system code, applications, programs, and the like, to perform the data processing tasks associated with information handling system 400.

In the host environment, processor 402 is connected to I/O interface 410 via processor interface 406, and processor 404 is connected to the I/O interface via processor interface 408. Memory 420 is connected to processor 402 via a memory interface 422. Memory 425 is connected to processor 404 via a memory interface 427. Graphics interface 430 is connected to I/O interface 410 via a graphics interface 432 and provides a video display output 436 to a video display 434. In a particular embodiment, information handling system 400 includes separate memories that are dedicated to each of processors 402 and 404 via separate memory interfaces. An example of memories 420 and 425 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 440, disk controller 450, and I/O bridge 470 are connected to I/O interface 410 via an I/O channel 412. An example of I/O channel 412 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 410 can also include one or more other I/O interfaces, including an Industry Standard Architecture (ISA) interface, a Small Computer Serial Interface (SCSI) interface, an Inter-Integrated Circuit (I2C) interface, a System Packet Interface (SPI), a Universal Serial Bus (USB), another interface, or a combination thereof. BIOS/UEFI module 440 includes BIOS/UEFI code operable to detect resources within information handling system 400, to provide drivers for the resources, initialize the resources, and access the resources. BIOS/UEFI module 440 includes code that operates to detect resources within information handling system 400, to provide drivers for the resources, to initialize the resources, and to access the resources.

Disk controller 450 includes a disk interface 452 that connects the disk controller to HDD 454, to ODD 456, and to disk emulator 460. An example of disk interface 452 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 460 permits SSD 464 to be connected to information handling system 400 via an external interface 462. An example of external interface 462 includes a USB interface, an IEEE 4394 (Firewire) interface, a proprietary interface, or a combination thereof. Alternatively, solid-state drive 464 can be disposed within information handling system 400.

I/O bridge 470 includes a peripheral interface 472 that connects the I/O bridge to add-on resource 474, to TPM 476, and to network interface 480. Peripheral interface 472 can be the same type of interface as I/O channel 412 or can be a different type of interface. As such, I/O bridge 470 extends the capacity of I/O channel 412 when peripheral interface 472 and the I/O channel are of the same type, and the I/O bridge translates information from a format suitable to the I/O channel to a format suitable to the peripheral channel 472 when they are of a different type. Add-on resource 474 can include a data storage system, an additional graphics interface, a network interface card (NIC), a sound/video processing card, another add-on resource, or a combination thereof. Add-on resource 474 can be on a main circuit board, on separate circuit board or add-in card disposed within information handling system 400, a device that is external to the information handling system, or a combination thereof.

Network interface 480 represents a NIC disposed within information handling system 400, on a main circuit board of the information handling system, integrated onto another component such as I/O interface 410, in another suitable location, or a combination thereof. Network interface device 480 includes network channels 482 and 484 that provide interfaces to devices that are external to information handling system 400. In a particular embodiment, network channels 482 and 484 are of a different type than peripheral channel 472 and network interface 480 translates information from a format suitable to the peripheral channel to a format suitable to external devices. An example of network channels 482 and 484 includes InfiniBand channels, Fibre Channel channels, Gigabit Ethernet channels, proprietary channel architectures, or a combination thereof. Network channels 482 and 484 can be connected to external network resources (not illustrated). The network resource can include another information handling system, a data storage system, another network, a grid management system, another suitable resource, or a combination thereof.

Management device 490 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 400. In particular, management device 490 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 400, such as system cooling fans and power supplies. Management device 490 can include a network connection to an external management system, and the management device can communicate with the management system to report status information for information handling system 400, to receive BIOS/UEFI or system firmware updates, or to perform other task for managing and controlling the operation of information handling system 400.

Management device 490 can operate off of a separate power plane from the components of the host environment so that the management device receives power to manage information handling system 400 when the information handling system is otherwise shut down. An example of management device 490 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 490 may further include associated memory devices, logic devices, security devices, or the like, as needed, or desired.

The systems and methods described herein utilize an AI model to provide adaptive offline analysis in hardened compliance and regulatory deployments using spike reasoning.

Specifically, the systems and methods described herein provide an adaptive offline analysis mechanism that dynamically adjusts processing policies based on the specific reasoning behind system spikes, e.g., based on specific causes of system spikes. Spikes may be categorized as constructive (e.g., flash sales) or destructive (e.g., DDOS attacks), with reasoning retrieved from a data accumulated from monitoring previous spikes or with reasoning inferred from the real-time data associated with the current spike and cause thereof. The AI model may tailor offline analysis policies specifically to the various spike types and therefor, reduce resource usage without sacrificing accuracy or security.

For example, for constructive spikes like a ticket sale, a smaller, domain-specific AI model optimized for ticket data replaces a general-purpose (one-size-fits-all) model, ensuring a faster, more efficient analysis. For a destructive spike like a DDOS attack, data affected by the attack is flagged as potentially polluted and excluded from analysis, preventing unnecessary resource expenditure. Further, for anomaly-induced spikes, policies fine-tuned by the AI model based on related anomalous scenarios are used, providing relevant and efficient analysis while conserving resources.

Additionally, the systems and methods disclosed herein may leverage contextual policies and modular model adjustments to manage spikes without the need for costly infrastructure scaling thereby maintaining both security hardening and performance. Further, the systems and methods herein uses real-time, or learned, spike reasoning to determine offline analysis policies that dynamically adjust resource-intensive processes to handle spikes (current and future) to enable efficient scaling without infrastructure expansion or compromised security. In other words, the systems and methods disclosed herein avoid simply responding to spikes by scaling infrastructure to manage those spikes. Thus, costs are minimized and the likelihood of introducing vulnerabilities into hardened compliance and regulatory systems is also minimized. Instead of using generic models, generic tools, and generic solutions for all spike scenarios, the systems and methods described herein utilize an adaptive AI model to tailor the responses to spikes based on the specific characteristics related to specific spikes in order to minimize, or obviate, inefficient resource utilization (or changes) during specific types of spikes.

Accordingly, the systems and methods herein provide an adaptive mechanism to differentiate between constructive and destructive spikes, and recognize anomalous spikes, and provide policies and responses that are less resource-intensive and more effective in diverse scenarios. As such, by employing an AI model to create context-specific policies and responses, when spikes are encountered, expensive infrastructure scaling may be avoided. Further, by not responding to spikes with broad infrastructure changes the hardened nature of a compliance and regulatory system may be maintained.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An information handling system, comprising:
a computer readable medium including an artificial intelligence (AI) adaptive policy model; and
a processor operably coupled to the computer readable medium to access the AI adaptive policy model to:
monitor one or more system resources;
determine when a spike in resource usage occurs;
when a spike in resource usage occurs, gather data related to the spike to determine a spike reasoning for the spike; and
provide an adaptive spike management policy based on the spike reasoning.

2. The information handling system of claim 1, the processor further to access the AI adaptive policy model to categorize the spike based on the spike reasoning as one of three spike types that include a constructive spike, a destructive spike, or an anomalous spike.

3. The information handling system of claim 2, the processor further to access the AI adaptive policy model to determine whether a spike management policy exists for the spike based on the spike reasoning and the spike type.

4. The information handling system of claim 3, the processor further to access the AI adaptive policy model to choose an exiting spike management policy for the spike based on the spike reasoning and spike type.

5. The information handling system of claim 4, the processor further to access the AI adaptive policy model to execute the existing spike management policy.

6. The information handling system of claim 3, the processor further to access the AI adaptive policy model to generate a new spike management policy for the spike based on the spike reasoning and spike type.

7. The information handling system of claim 6, the processor further to access the AI adaptive policy model to store the new spike management policy for the spike in conjunction with the spike reasoning and spike type.

8. The information handling system of claim 7, the processor further to access the AI adaptive policy model to execute the new spike management policy.

9. A method of providing adaptive spike management policies in an information handling system using an artificial intelligence (AI) adaptive policy model, the method including:
monitoring one or more system resources;
determining when a spike in resource usage occurs;
gathering data related to the spike to determine a spike reasoning for the spike, when a spike in resource usage occurs; and
categorizing the spike based on the spike reasoning as one of three spike types that include a constructive spike, a destructive spike, or an anomalous spike.

10. The method of claim 9, further comprising determining whether a spike management policy exists for the spike based on the spike reasoning and the spike type.

11. The method of claim 10, further comprising choosing an exiting spike management policy for the spike based on the spike reasoning and spike type.

12. The method of claim 11, further comprising executing the existing spike management policy.

13. The method of claim 10, further comprising generating a new spike management policy for the spike based on the spike reasoning and spike type.

14. The method of claim 13, further comprising storing the new spike management policy for the spike in conjunction with the spike reasoning and spike type.

15. The method of claim 14, further comprising executing the new spike management policy.

16. An information handling system, comprising:
a computer readable medium including an artificial intelligence (AI) adaptive policy model; and
a processor operably coupled to the computer readable medium to access the AI adaptive policy model to:
monitor one or more system resources; and
when a spike in resource usage occurs,
gather data related to the spike to determine a spike reasoning for the spike; and
categorize the spike based on the spike reasoning as one of three spike types that include a constructive spike, a destructive spike, or an anomalous spike.

17. The information handling system of claim 16, the processor further to access the AI adaptive policy model to determine whether a spike management policy exists for the spike based on the spike reasoning and the spike type.

18. The information handling system of claim 17, the processor further to:
access the AI adaptive policy model to choose an exiting spike management policy for the spike based on the spike reasoning and spike type; and
execute the existing spike management policy.

19. The information handling system of claim 16, the processor further to access the AI adaptive policy model to generate a new spike management policy for the spike based on the spike reasoning and spike type.

20. The information handling system of claim 19, the processor further to:
access the AI adaptive policy model to store the new spike management policy for the spike in conjunction with the spike reasoning and spike type; and
execute the new spike management policy.
